(19) United States
(12) Patent Application Publication
(10) Pub. No.: US 2023/0417785 A1
(43) Pub. Date: Dec. 28, 2023

(54) SUBSTANCE SEPARATING DEVICE, ANALYSIS DEVICE, AND ANALYSIS METHOD

(71) Applicant: TIANMA JAPAN, LTD., Kawasaki (JP)

(72) Inventors: Ayuko IMAI, Kawasaki (JP); Ken SUMIYOSHI, Kawasaki (JP); Koji SHIGEMURA, Kawasaki (JP)

(73) Assignee: TIANMA JAPAN, LTD., Kawasaki (JP)

(21) Appl. No.: 18/336,557

(22) Filed: Jun. 16, 2023

(30) Foreign Application Priority Data
Jun. 23, 2022 (JP) 2022-101265

(51) Int. Cl. G01N 35/10; B01D 61/24

(52) U.S. Cl. CPC G01N 35/10; B01D 61/243; G01N 2035/1053; G01N 2035/00475

(57) ABSTRACT

A substance separating device includes a reaction vessel provided with an interior that is partitioned into a first chamber and a second chamber by a dialysis membrane, a solution being stored in the reaction vessel. A specimen is stored in the first chamber, and dye-modified molecule that has a binding ability for specifically binding to a substance to be measured having a molecular weight greater than a molecular weight cut-off the dialysis membrane is stored in at least one of the first chamber and the second chamber. The dye-modified molecule has a molecular weight that is less than the molecular weight cut-off of the dialysis membrane.

### CROSS-REFERENCE TO RELATED APPLICATIONS

This application claims the benefit of Japanese Patent Application No. 2022-101265, filed on Jun. 23, 2022, the entire disclosure of which is incorporated by reference herein.

### FIELD OF THE INVENTION

The present disclosure relates generally to a substance separating device, an analysis device, and an analysis method.

### BACKGROUND OF THE INVENTION

Immunoassays are analysis methods that use antibody-antigen reactions (see, for example, Unexamined Japanese Patent Application Publication No. H11-44688). With an immunoassay, it is possible to use an antibody that specifically binds to a substance to be measured to detect an antigen with good sensitivity. Among immunoassays, the nonuniform method is known as a high-sensitivity measuring method. In this method labeled antigens (bound, B) bound to an antibody and free labeled antigens (free, F) are separated (B/F separation). However, other apparatuses are needed to perform the B/F separation, which complicates the measuring system. As such, there is a demand for a method in which B/F separation is unnecessary.

In B/F separation, generally, a solid-phase method in which the antibodies are immobilized and then washed is used. However, the solid-phase method has the following problems:
(1) A reagent for the immobilization, surface treatments, and the like are needed
(2) The antibody immobilization must be performed at high density so as to be distinguishable from the later non-specific binding
(3) Time is required to perform the work of antibody immobilization
(4) Antibody immobilization states may vary depending on the target surface
(5) Since multiple processes are needed in the measuring, B/F separation is not suited for simple analyses

Meanwhile, dialysis has long been known as a B/F separation means that does not require washing. However, in a dialysis-based B/F separation method, the molecular size of the antigen (substance to be measured) must be sufficiently smaller than that of the antibody. Accordingly, this method is not suited for accurately measuring proteins and similar substances that have large molecular weights.

### SUMMARY OF THE INVENTION

A substance separating device according to a first aspect of the present disclosure includes:
a reaction vessel provided with an interior that is partitioned into a first chamber and a second chamber by a dialysis membrane, a solution being stored in the reaction vessel, wherein
a specimen is stored in the first chamber,
a dye-modified molecule that has a binding ability for specifically binding to a substance to be measured is stored in at least one of the first chamber and the second chamber, the substance to be measured being included in the specimen and having a molecular weight that is greater than a molecular weight cut-off of the dialysis membrane, and
the dye-modified molecule has a molecular weight that is less than the molecular weight cut-off of the dialysis membrane.

An analysis device according to a second aspect of the present disclosure includes:
the substance separating device according to the first aspect; and
a detection optical system that emits, on at least one of the first chamber and the second chamber of the reaction vessel of the substance separating device, an excitation light that excites a dye and, also, detects an emission intensity, or the emission intensity and a degree of polarization, of a portion on which the excitation light is emitted.

An analysis method according to a third aspect of the present disclosure includes:
storing a specimen in, of a first chamber and a second chamber of a reaction vessel in which a solution is stored and that is partitioned by a dialysis membrane, the first chamber; and
storing, in at least one of the first chamber and the second chamber, a dye-modified molecule that has a binding ability for specifically binding to a substance to be measured and that has a molecular weight that is less than a molecular weight cut-off of the dialysis membrane, the substance to be measured being included in the specimen and having a molecular weight that is greater than the molecular weight cut-off of the dialysis membrane.

It is to be understood that both the foregoing general description and the following detailed description are exemplary and explanatory and are not restrictive of this disclosure.

### BRIEF DESCRIPTION OF DRAWINGS

A more complete understanding of this application can be obtained when the following detailed description is considered in conjunction with the following drawings, in which:

FIG. 1A is a perspective view illustrating the configuration of a reaction vessel of a substance separating device according to Embodiment 1 of the present disclosure;

FIG. 1B is a schematic view illustrating substances stored in the reaction vessel of FIG. 1A;

FIG. 2 is a flowchart illustrating analysis processing according to Embodiment 1 of the present disclosure;

FIG. 3 is a perspective view illustrating a modified example of the reaction vessel of the substance separating device according to Embodiment 1 of the present disclosure;

FIG. 4 is a schematic view illustrating the configuration of an analysis device according to Embodiment 2 of the present disclosure;

FIG. 5 is a flowchart illustrating analysis processing according to Embodiment 2 of the present disclosure;

FIG. 6A is a first schematic view illustrating an example of a specimen and a molecule added to a first reaction vessel and a second reaction vessel of a substance separating device according to Embodiment 3 of the present disclosure;

FIG. 6B is a second schematic view illustrating an example of the specimen and the molecule added to the first reaction vessel and the second reaction vessel of the substance separating device according to Embodiment 3 of the present disclosure;

FIG. 7 is a schematic view illustrating the configuration of an analysis device according to Embodiment 4 of the present disclosure;

FIG. 8 is a schematic view illustrating the configuration of an analysis device according to Embodiment 5 of the present disclosure; and

FIG. 9 is a schematic view illustrating the configuration of an analysis device according to Embodiment 6 of the present disclosure.

### DETAILED DESCRIPTION OF THE INVENTION

Embodiments of the present disclosure are described while referencing the drawings. Note that the present disclosure is not limited by the embodiments and drawings described below. Additionally, note that, in the following embodiments, the expressions “having” and “including”, or “containing” also include the meanings of “comprising” or “constituted from.”

### Embodiment 1

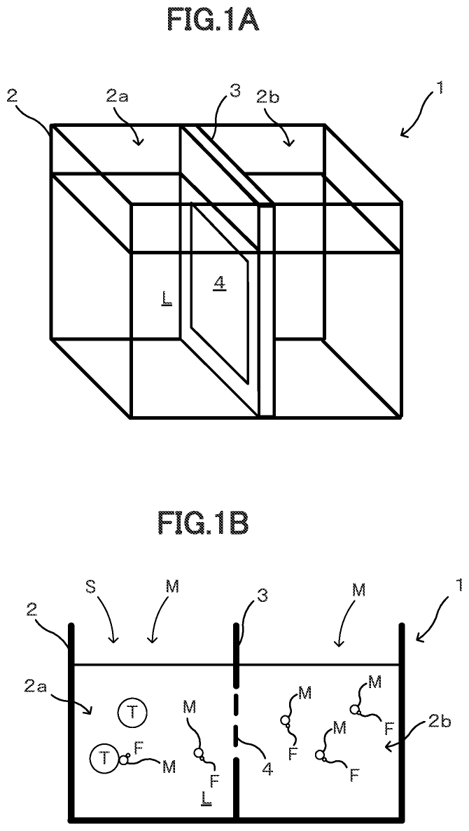

As illustrated in FIG. 1A, a substance separating device 1 according to the present embodiment includes a reaction vessel 2. The interior of the reaction vessel 2 in which a solution L is stored is partitioned into two rooms by a partition wall 3. One of the rooms is referred to as a first chamber 2a, and the other of the rooms is referred to as a second chamber 2b.

A dialysis membrane 4 is provided on at least a portion of the partition wall 3. The solution L can pass between the first chamber 2a and the second chamber 2b via the dialysis membrane 4. As the dialysis membrane 4, a material resistant to the solution L, that is, as described later, a material having a predetermined molecular weight cut-off (MWCO) in relation to the molecular weights of the substance to be measured T and a dye-modified molecule M is used.

As illustrated in FIG. 1B, the specimen S that is the object to be measured is stored in the first chamber 2a. The substance to be measured T is contained in the specimen S. Meanwhile, the dye-modified molecule M is stored in at least one of the first chamber 2a and the second chamber 2b. The dye-modified molecule M is modified (labeled) by a fluorochrome F serving as a dye. The dye-modified molecule M has a binding ability for specifically binding to the substance to be measured T.

The molecular weight of the substance to be measured T is greater than the molecular weight cut-off (MWCO) of the dialysis membrane 4. Accordingly, the substance to be measured T remains stored in the first chamber 2a and does not migrate to the second chamber 2b. Meanwhile, the molecular weight of the dye-modified molecule M is less than the MWCO of the dialysis membrane 4. Accordingly, when the dye-modified molecule M is not bound to the substance to be measured T, the dye-modified molecule M can migrate between the first chamber 2a and the second chamber 2b via the dialysis membrane 4. The dye-modified molecule M that migrates to the first chamber 2a binds to the substance to be measured T.

When the concentration of the substance to be measured T is high, a large number of the dye-modified molecules M bind to the substance to be measured T in the first chamber 2a. As the concentration of the substance to be measured T increases, the number of the dye-modified molecules M that bind to the substance to be measured T increases, and the concentration of the dye-modified molecule M decreases. Meanwhile, when the concentration of the substance to be measured T is low, the number of the dye-modified molecules M (bonded molecules) that bind to the substance to be measured T in the first chamber 2a is small and, as such, the number of the dye-modified molecules M (free molecules) that are not bonded to the substance to be measured T increases.

Thus, the number of bonded dye-modified molecules M and the number of free dye-modified molecules M change depending on the concentration of the substance to be measured T. Meanwhile, an emission intensity P1, or the like, of the fluorochrome F in a case in which excitation light that excites the fluorochrome F is emitted on the first chamber 2a or the second chamber 2b, changes in accordance with the concentration of the substance to be measured T in the first chamber 2a. Accordingly, provided that the emission intensity P1 or the like is detected, the concentration of the substance to be measured T can be estimated.

Note that, although the bonded molecules (conjugates) of the substance to be measured T and the dye-modified molecule M remain in the first chamber 2a unable to migrate to the second chamber 2b via the dialysis membrane 4, the concentration of the free dye-modified molecules M in the first chamber 2a and the second chamber 2b becomes the same in an equilibrium state after a certain amount of time has passed. As such, as illustrated in FIG. 1B, a state in which bonded and free molecules coexist in the first chamber 2a is attained. This matter must be taken into consideration when estimating the concentration of the substance to be measured T on the basis of the emission intensity P1.

### Substance to be Measured, Dye-Modified Molecule, and Dialysis Membrane

A macromolecule such as, for example, a protein or the like can be selected as the substance to be measured T. Examples thereof include ovalbumin and β-lactoglobulin. When ovalbumin (molecular weight: 43 kDa) is the substance to be measured T, a variable domain heavy-chain (VHH) antibody (molecular weight: 15 kDa), for example, can be selected as the dye-modified molecule M. In such a case, the MWCO of the dialysis membrane 4 can, for example, be set to 20 kDa. When β-lactoglobulin (molecular weight: 18.3 kDa) is the substance to be measured T, an aptamer (for example, molecular weight: 8 kDa) can be selected as the dye-modified molecule M. In such a case, the MWCO of the dialysis membrane 4 can, for example, be set to 10 kDa. Additionally, a Fab antibody may be used as the dye-modified molecule M. Thus, the MWCO of the dialysis membrane 4 is determined on the basis of the substance to be measured T and the dye-modified molecule M.

### Fluorochrome

The fluorochrome F is a dye that emits fluorescence when excited with excitation light. Each fluorochrome F has its own fluorescence lifetime. In the present disclosure, a fluorochrome F with a fluorescence lifetime of 1 to 10 ns, a fluorochrome F with a fluorescence lifetime of greater than 10 ns to 200 ns F, or a fluorochrome F with a fluorescence lifetime of greater than 200 ns to 3,000 ns F can be appropriately selected and used in accordance with the molecular weight and the like of the dye-modified molecule M to be modified. Examples of the fluorochrome F with a fluorescence lifetime of 1 to 10 ns include fluorescein compounds such as indolenine, chlorotriazinylaminofluorescein, 4′-aminomethylfluorescein, 5-aminomethylfluorescein, 6-aminomethylfluorescein, 6-carboxyfluorescein, 5-carboxyfluorescein, 5- and 6-aminofluorescein, thioureafluorescein, methoxytriazinylaminofluorescein, and the like; rhodamine derivatives such as rhodamine B, rhodamine 6G, rhodamine 6GP, and the like; and, as registered trademarks or trade names, Alexa Fluor series such as Alexa Fluor 488, BODIPY series, DY series, ATTO series, Dy Light series, Oyster series, HiLyte Fluor series, Pacific Blue, Marina Blue, Acridine, Edans, Coumarin, DANSYL, FAN, Oregon Green, Rhodamine Green-X, NBD-X, TET, JOE, Yakima Yellow, VIC, HEX, R6G, Cy3, TAMRA, Rhodamine Red-X, Redmond Red, ROX, Cal Red, Texas Red, LC Red 640, Cy5, Cy5.5, and LC Red 705. Examples of the fluorochrome F with a fluorescence lifetime of greater than 10 ns to 200 ns include naphthalene derivatives such as dialkylaminonaphthalenesulfonyl and the like, and pyrene derivatives such as N-(1-pyrenyl)maleimide, aminopyrene, pyrenebutanoic acid, alkynylpyrene, and the like. Examples of the fluorochrome F with a fluorescence lifetime of greater than 200 ns to 3,000 ns include metal complexes such as platinum, rhenium, ruthenium, osmium, europium, and the like.

To modify (label) the molecule M with the fluorochrome F, it is sufficient that, for example, the fluorochrome F and the molecule M are directly covalently bonded or bonded via a linker such as oligoethylene glycol, an alkyl chain, or the like. The fluorochrome F has a functional group that can bind to the carboxyl group, the amino group, the hydroxyl group, the thiol group, the phenyl group, or the like of the molecule. The molecule M can be labeled with the fluorochrome F by reacting the respective functional groups of the fluorochrome F and the molecule M under known conditions. Note that the number of molecules of the fluorochrome F that modifies one molecule can be selected as desired. It is preferable that there is one molecule or more of the fluorochrome F, and there may be from two to five molecules, per one molecule.

Next, an analysis method, that is, analysis processing using the substance separating device 1 according to the present embodiment is described. Note that, it is presumed that a dialysis membrane 4 having an MWCO that is less than the molecular weight of the substance to be measured T and greater than the molecular weight of the dye-modified molecule M is installed on the partition wall 3, and that the solution L is stored in the reaction vessel 2.

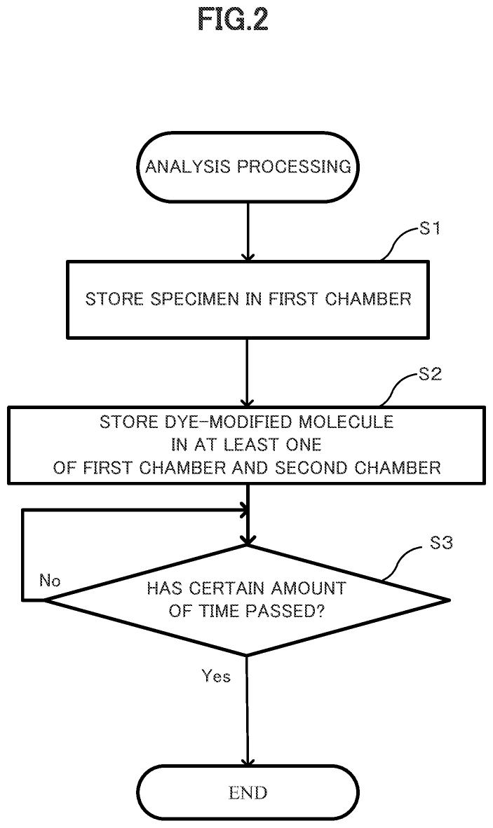

In the analysis processing, as illustrated in FIG. 2, firstly, the specimen S is stored in the first chamber 2a (step S1). Next, the dye-modified molecule M is stored in at least one of the first chamber 2a and the second chamber 2b (step S2). Thereafter, a certain amount of time is allowed to pass (step S3; No). After the certain amount of time has passed (step S3; Yes), the analysis method by the substance separating device 1 is ended.

After the certain amount of time has passed, in the reaction vessel 2, the dye-modified molecules M bonded to the substance to be measured T (bonded molecule) remain in the first chamber 2a and do not migrate to the second chamber 2b. Accordingly, in one example, the solution L in the first chamber 2a or the second chamber 2b is moved to a measurement cell, and the excitation light that causes the fluorochrome F to emit light is emitted on the measurement cell. Provided that the emission intensity P1, or the emission intensity P1 and the degree of polarization P2, of the fluorescence of the measurement cell is detected, the concentration of the substance to be measured T can be measured as described later.

As described in detail above, according to the substance separating device 1 according to the present embodiment, the bonded molecules consisting of the dye-modified molecules M being bonded to the substance to be measured T can be retained in the first chamber 2a by using the dialysis membrane 4 that has a molecular weight cut-off (MWCO) that is less than the molecular weight of the substance to be measured T and that is greater than the molecular weight of the dye-modified molecule M that specifically binds to the substance to be measured T. As such, provided that the emission intensity P1 and the degree of polarization P2 of the fluorochrome F of at least one of the first chamber 2a and the second chamber 2b is detected, the substance to be measured T, which has a high molecular weight, can be quantitatively measured in an accurate manner.

Using the analysis device 5 according to the present embodiment enables B/F separation in an immunoassay for a case in which, for example, the substance to be measured T is an antigen and the dye-modified molecule M is an antibody. Due to this, the need for antibody immobilization work is eliminated.

The reaction vessel 2 itself can be used as the measurement cell. In such a case, the process of moving the solution L from the reaction vessel 2 to the measurement cell can be eliminated, and contamination of the specimen S can be prevented. Note that, in this case, a material that transmits the excitation light and fluorescence must be selected as the material of the reaction vessel 2.

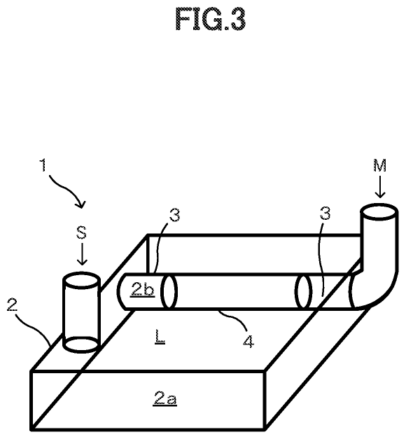

A reaction vessel 2 that serves as the measurement cell can be provided with the configuration illustrated in FIG. 3. The reaction vessel 2 illustrated in FIG. 3 has a configuration in which a tube-like second chamber 2b is inserted into a rectangular parallelepiped first chamber 2a. A tube-like dialysis membrane 4 (dialysis tube) is formed on the wall of the second chamber 2b. The substance to be measured T is added to the first chamber 2a, and the dye-modified molecule M is added to the second chamber 2b. The dye-modified molecule M passes through the dialysis membrane 4 (dialysis tube), enters the first chamber 2a, and binds to the substance to be measured T. This reaction vessel 2 can also be formed from a material that transmits the excitation light and fluorescence.

### Embodiment 2

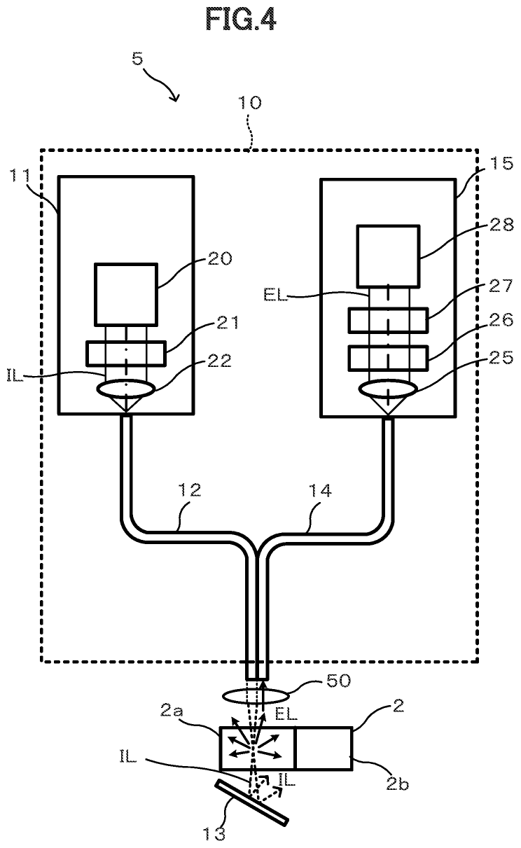

In the present embodiment, an analysis device 5 provided with the reaction vessel 2 according to Embodiment 1 as the measurement cell is described. As illustrated in FIG. 4, the analysis device 5 according to the present embodiment includes the reaction vessel 2 according to Embodiment 1, and a detection optical system 10. As the reaction vessel 2, a reaction vessel having the configuration illustrated in FIG. 1A may be used, or a reaction vessel having the configuration illustrated in FIG. 3 may be used.

The detection optical system 10 emits an excitation light IL that excites the fluorochrome F (see FIG. 1B) on the first chamber 2a of the reaction vessel 2 of the substance separating device 1 and, also, detects the emission intensity P1, or the emission intensity P1 and the degree of polarization P2, of a fluorescence EL of the first chamber 2a.

The detection optical system 10 includes a light source unit 11, an optical fiber 12, a lens 50, a reflecting mirror 13 disposed diagonal with respect to an optical axis direction of an exit end of the excitation light IL of the optical fiber 12 (hereinafter referred to simply as “diagonal”), an optical fiber 14, and a detector 15.

The light source unit 11 includes a light source 20, an excitation filter 21, and a coupling lens 22. The light source 20 emits the excitation light IL. The excitation light IL passes through the excitation filter 21 that adjusts the wavelength of the excitation light IL and the coupling lens 22, and enters the optical fiber 12.

The optical fiber 12 sends the excitation light IL to the first chamber 2a of the reaction vessel 2 via the lens 50. The excitation light IL is focused in the liquid by the lens 50, and fluorescence EL is generated by the fluorochrome F in the first chamber 2a near this focal point. The reflecting mirror 13 is disposed diagonally, and diffuses/reflects the excitation light IL that transmits through the reaction vessel 2. The fluorescence EL generated by the luminescence of the fluorochrome F enters the optical fiber 14. The optical fiber 14 sends the fluorescence EL generated in the first chamber 2a to the detector 15.

The detector 15 includes a coupling lens 25, a fluorescence filter 26, a liquid crystal element 27, and an imager 28. The coupling lens 25 sends the light that exits from the optical fiber 14 to the fluorescence filter 26. The fluorescence filter 26 transmits light in the wavelength band of the fluorescence EL generated by the luminescence of the fluorochrome F, and blocks the light of other wavelengths. The liquid crystal element 27 adjusts the polarization direction of the transmitted fluorescence EL. The imager 28 captures an image expressing the fluorescence EL that transmits the liquid crystal element 27. It is possible to detect, on the basis of this image, the emission intensity P1, or the emission intensity P1 and the degree of polarization P2, of the fluorescence EL.

The emission intensity P1, or the emission intensity P1 and the degree of polarization P2, of the fluorescence EL in the first chamber 2a of the reaction vessel 2 is detected by the detection optical system 10 having the configuration described above.

### Emission Intensity of Fluorescence

When detecting the emission intensity P1 of the fluorescence EL, the liquid crystal element 27 is adjusted such that all polarization components of the entering fluorescence EL are transmitted. Due to this, the imager 28 is caused to receive all of the luminous flux of the fluorescence EL, and can detect the emission intensity P1. A calibration curve representing the relationship between the emission intensity P1 of the fluorescence EL and the concentration of the dye-modified molecule M is prepared in advance, and the analysis device 5 measures the concentration of the dye-modified molecule M corresponding to the emission intensity P1 on the basis of this calibration curve. Note that a calibration curve is prepared by detecting, for combinations of the substance to be measured T and the dye-modified molecule M for which the concentrations are known, the emission intensity P1 of the fluorescence EL in the first chamber 2a or the second chamber 2b while changing the concentrations thereof.

### Degree of Polarization of Fluorescence

When detecting the degree of polarization P2 of the fluorescence EL, the excitation light IL emitted from the light source unit 11 is linearly polarized light. Of the received fluorescence EL, the degree of polarization parallel to the excitation light IL is defined as I1, and the degree of polarization perpendicular to the excitation light IL is defined as I2. The detection optical system 10 controls the liquid crystal element 27 of the detector 15 to detect these two degrees of fluorescence polarization I1, I2, and uses the following equation to calculate the degree of polarization P2.

P2=(I1−I2)/(I1+I2)

The degree of polarization P2 expresses how much the dye-modified molecule M rotates in a period from excitation to when the fluorescence EL is emitted. Molecules with low molecular weight rotate vigorously in solution due to Brownian motion and, as such, the degree of polarization P2 is low. Molecules with high molecular weight have weak Brownian motion and, as such, the degree of polarization P2 rises. Accordingly, the degree of polarization P2 increases as the concentration of the substance to be measured T increases, and the degree of polarization P2 decreases as the concentration decreases. A calibration curve representing the relationship between the degree of polarization P2 and the concentration of the substance to be measured T is prepared in advance. The analysis device 5 measures the concentration of the substance to be measured T corresponding to the degree of polarization P2 on the basis of this calibration curve. Note that this calibration curve is also prepared by detecting, for combinations of the substance to be measured T and the dye-modified molecule M for which the concentrations are known, the degree of polarization P2 of the fluorescence EL in the first chamber 2a or the second chamber 2b while changing the concentrations thereof.

Meanwhile, although the MWCO of the dialysis membrane 4 is less than the molecular weight of the substance to be measured T, the MWCO is a statistical numerical value, and the size of the holes of the dialysis membrane 4 varies. Consequently, a small amount of the substance to be measured T may pass through the dialysis membrane 4 and migrate to the second chamber 2b. In such a case, the analysis device 5 may, for example, measure both the emission intensity P1 and the degree of polarization P2 of the fluorescence EL. For example, the emission intensity P1 of the fluorescence EL in the second chamber 2b reflects both the dye-modified molecules M bonded to the substance to be measured T (bonded molecules) and the dye-modified molecules M not bonded to the substance to be measured T (free molecules). Furthermore, the degree of polarization P2 of the fluorescence EL in the second chamber 2b reflects a ratio of the concentration of the bonded molecules to the concentration of the free molecules. Accordingly, by estimating the overall concentration of the dye-modified molecule M on the basis of the emission intensity P1 and estimating the ratio of the bonded molecules to the free molecules on the basis of the degree of polarization P2, it is possible to measure, with high accuracy, the concentration of the substance to be measured T to which the dye-modified molecule M binds. Note that, the added amount of the dye-modified molecule M to be added must be known in order to estimate the ratio of the bonded molecules to the free molecules.

Note that, with the analysis device 5, a configuration is possible in which the excitation light IL is emitted on the second chamber 2b, the emission intensity P1, or the emission intensity P1 and the degree of polarization P2, of the fluorescence EL in the second chamber 2b is detected, and the concentration of the substance to be measured T is measured. It is possible to estimate the concentration of the substance to be measured T on the basis of both the detection results of the first chamber 2a and the detection results of the second chamber 2b. Additionally, the first chamber 2a and the second chamber 2b are separated by the dialysis membrane 4, but a configuration is possible in which, in addition to the dialysis membrane 4, a light-blocking layer is disposed between the first chamber 2a and the second chamber 2b. Due to this configuration, optical signals obtained from the first chamber 2a can be isolated from optical signals of the second chamber 2b, thereby making it possible to monitor, with greater accuracy, fluorescence signals of each chamber.

Next, an analysis method, that is, analysis processing using the analysis device 5 is described.

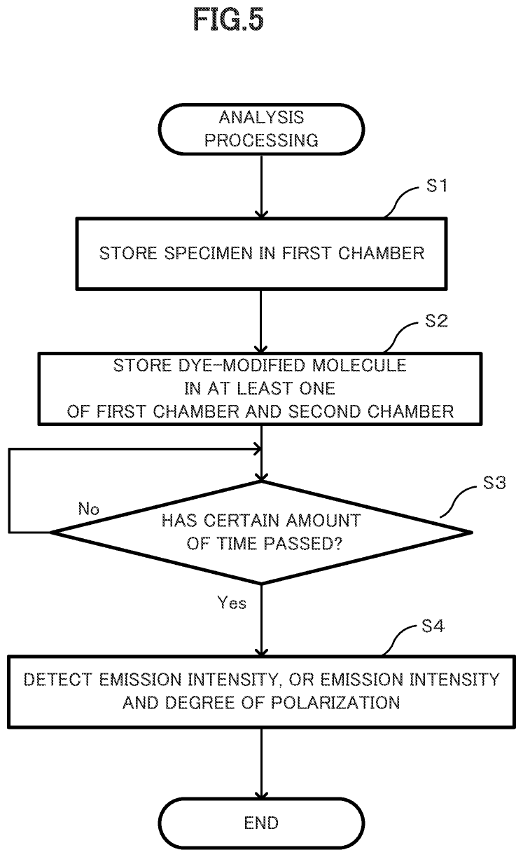

As illustrated in FIG. 5, the analysis processing according to the present embodiment includes steps S1 to S3 that are the same as in the analysis processing described above (see FIG. 2). After the certain amount of time has passed (step S3; Yes), the excitation light IL that excites the fluorochrome F is emitted on at least one of the first chamber 2a and the second chamber 2b of the reaction vessel 2, and, also, the emission intensity P1, or the emission intensity P1 and the degree of polarization P2, of the fluorescence EL of the portion, of the first chamber 2a and the second chamber 2b, on which the excitation light IL is emitted is detected (step S4). Then, the concentration of the substance to be measured T is calculated from this detection results on the basis of the various calibration curves. After step S4 ends, the analysis device 5 ends the analysis processing.

According to the present embodiment, by using the reaction vessel 2 as the measurement cell, the need to move the solution can be eliminated, and contamination of the sample can be prevented.

### Embodiment 3

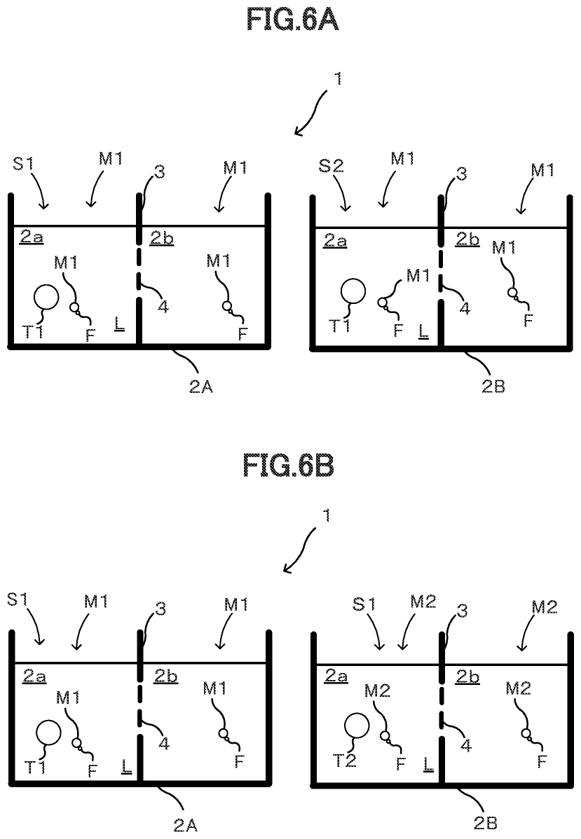

As illustrated in FIGS. 6A and 6B, a reaction vessel 2 of a substance separating device 1 according to the present embodiment includes a first reaction vessel 2A and a second reaction vessel 2B. In this case, in, for example, the case illustrated in FIG. 6A, a specimen S1 can be added to the first chamber 2a of the first reaction vessel 2A, and a dye-modified molecule M1 that binds to a substance to be measured T1 can be added to at least one of the first chamber 2a and the second chamber 2b. Furthermore, a specimen S2 can be added to the first chamber 2a of the second reaction vessel 2B, and the dye-modified molecule M1 can be added to at least one of the first chamber 2a and the second chamber 2b. After the certain amount of time has passed, the excitation light IL that excites the fluorochrome F is emitted on at least one of the first chamber 2a and the second chamber 2b of the first reaction vessel 2A, and, also, the emission intensity P1, or the emission intensity P1 and the degree of polarization P2, of the fluorescence EL of the portion, of the first chamber 2a and the second chamber 2b, on which the excitation light IL is emitted is detected; and if the excitation light IL that excites the fluorochrome F is emitted on at least one of the first chamber 2a and the second chamber 2b of the 2 of the second reaction vessel 2B and, also, the emission intensity P1, or the emission intensity P1 and the degree of polarization P2, of the fluorescence EL of the portion, of the first chamber 2a and the second chamber 2b, on which the excitation light IL is emitted is detected. As a result, the concentrations of the substance to be measured T in the specimens S1, S2 of different types can be measured at once. As a result, the concentrations of the substance to be measured T can be compared between the specimen S1 and the specimen S2.

In, for example, the case illustrated in FIG. 6B, the specimen S1 can be added to the first chamber 2a of the first reaction vessel 2A, and the dye-modified molecule M1 that binds to a substance to be measured T1 can be added to at least one of the first chamber 2a and the second chamber 2b, the specimen S1 can be added to the first chamber 2a of the second reaction vessel 2B, and a dye-modified molecule M2 that binds to the substance to be measured T2 can be added to at least one of the first chamber 2a and the second chamber 2b. After the certain amount of time has passed after adding, as with the case of FIG. 6A, as a result of the excitation light IL being emitted, provided that the emission intensity P1, or the emission intensity P1 and the degree of polarization P2, of the fluorescence EL of the first reaction vessel 2A is detected, and if the emission intensity P1, or the emission intensity P1 and the degree of polarization P2, of the fluorescence EL of the second reaction vessel 2B is detected, the concentrations of the different types of substances to be measured T1, T2 in the specimen S1 can be measured at once. As a result, the concentrations of the substances to be measured T1, T2 in specimens S1 of the same type can be compared.

Thus, preparing the plurality of reaction vessels 2A, 2B makes it possible to simultaneously measure the concentrations of the substance to be measured T for combinations of substances to be measured T of different types and the dye-modified molecule M.

### Embodiment 4

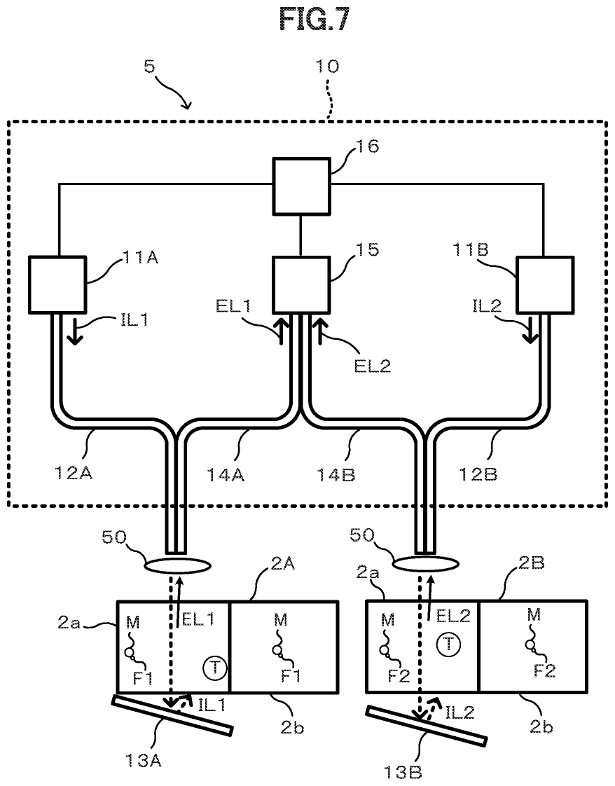

As illustrated in FIG. 7, an analysis device 5 according to the present embodiment includes a detection optical system 10 that is capable of detecting, as a batch, an emission intensity P1, or the emission intensity P1 and a degree of polarization P2, of a fluorescence EL in a first reaction vessel 2A, and the emission intensity P1, or the emission intensity P1 and the degree of polarization P2, of the fluorescence EL in a second reaction vessel 2B. The detection optical system 10 includes a first light source unit 11A, a second light source unit 11B, an optical fiber 12A, an optical fiber 12B, and two lenses 50.

The internal configurations of the first light source unit 11A and the second light source unit 11B are the same as the configuration of the light source unit 11 of FIG. 4. The first light source unit 11A emits a first excitation light IL1 that excites a first fluorochrome F1. The second light source unit 11B emits a second excitation light IL2 that has a different wavelength than the first excitation light IL1 and that excites a second fluorochrome F2. The optical fiber 12A sends the first excitation light IL1 emitted from the first light source unit 11A to the first chamber 2a of the first reaction vessel 2A via the lens 50. The optical fiber 12B sends the second excitation light IL2 emitted from the second light source unit 11B to the first chamber 2a of the second reaction vessel 2B via the lens 50.

The dye-modified molecule M stored in the first chamber 2a of the first reaction vessel 2A is modified with the first fluorochrome F1 that emits light when irradiated with the first excitation light IL1. Accordingly, the dye-modified molecule M that binds to the substance to be measured T emits a fluorescence EL1 near the focus position of the first excitation light IL1 by the lens 50 in the first chamber 2a of the first reaction vessel 2A. The dye-modified molecule M stored in the first chamber 2a of the second reaction vessel 2B is modified with the second fluorochrome F2 that emits light when irradiated with the second excitation light IL2. Accordingly, the dye-modified molecule M that binds to the substance to be measured T emits a fluorescence EL2 near the focus position of the second excitation light IL2 by the lens 50 in the first chamber 2a of the second reaction vessel 2B.

The detection optical system 10 includes a diagonally disposed reflecting minor 13A, a similarly diagonally disposed reflecting mirror 13B, an optical fiber 14A, an optical fiber 14B, a detector 15, and a controller 16. The reflecting mirror 13A diffuses/reflects the first excitation light IL1 that transmits through the first reaction vessel 2A. Likewise, the reflecting minor 13B diffuses/reflects the second excitation light IL2 that transmits through the second reaction vessel 2B. Meanwhile, the fluorescence EL1 from the dye-modified molecule M in the first chamber 2a of the first reaction vessel 2A is condensed into the optical fiber 14A by the lens 50, and the optical fiber 14A sends, to the detector 15, light including the fluorescence EL1 generated in the first chamber 2a of the first reaction vessel 2A. Likewise, the fluorescence EL2 from the dye-modified molecule M in the first chamber 2a of the second reaction vessel 2B is condensed into the optical fiber 14B by the lens 50, and the optical fiber 14B sends, to the detector 15, light including the fluorescence EL2 generated in the first chamber 2a of the second reaction vessel 2B.

The detector 15 individually detects the emission intensity P1, or the emission intensity P1 and the degree of polarization P2, of the fluorescence EL1 in the first chamber 2a of the first reaction vessel 2A, and the emission intensity P1, or the emission intensity P1 and the degree of polarization P2, of the fluorescence EL2 in the first chamber 2a of the second reaction vessel 2B. At a first sampling time, the controller 16 controls so as to cause the first excitation light IL1 to be emitted from the first light source unit 11A and, also, to stop the emission of the second excitation light IL2 from the second light source unit 11B. At a second sampling time, the controller 16 controls so as to cause the second excitation light IL2 to be emitted from the second light source unit 11B and, also, to stop the emission of the first excitation light IL1 from the first light source unit 11A. The controller 16 controls the first light source unit 11A, the second light source unit 11B, and the detector 15 such that the first sampling time and the second sampling time are repeated. As a result, at the first sampling time, the emission intensity P1, or the emission intensity P1 and the degree of polarization P2, of the fluorescence EL1 in the first chamber 2a of the first reaction vessel 2A is acquired by the detector 15 and, at the second sampling time, the emission intensity P1, or the emission intensity P1 and the degree of polarization P2, of the fluorescence EL2 in the first chamber 2a of the second reaction vessel 2B is acquired by the detector 15.

Note that a configuration is possible in which the detector 15 includes a dichroic minor that separates the fluorescence EL1 and the fluorescence EL2, an image sensor that detects the intensity of the fluorescence EL1, and an image sensor that detects the intensity of the fluorescence EL2. With such a configuration, the fluorescence EL1 and the fluorescence EL2 can be separated by the dichroic mirror, and the emission intensity P1, or the emission intensity P1 and the degree of polarization P2, of the first reaction vessel 2A, and the emission intensity P1, or the emission intensity P1 and the degree of polarization P2, of second reaction vessel 2B can be individually detected by the respective image sensors.

As in Embodiment 3, a configuration is possible in which the target of the detection of the emission intensity P1 and the degree of polarization P2 is the second chamber 2b, or both the first chamber 2a and the second chamber 2b, of the first reaction vessel 2A and the second reaction vessel 2B. Additionally, the first chamber 2a and the second chamber 2b are separated by the dialysis membrane 4, but a configuration is possible in which, in addition to the dialysis membrane 4, a light-blocking layer is disposed between the first chamber 2a and the second chamber 2b. Due to this configuration, optical signals from the first chamber 2a can be isolated from optical signals from the second chamber 2b, thereby making it possible to monitor the fluorescence signals of each chamber with greater accuracy.

As illustrated in FIG. 6A, combinations of the substance to be measured T and the dye-modified molecule M stored in the first reaction vessel 2A and the second reaction vessel 2B can be combinations of the substance to be measured T1 and the dye-modified molecule M1. Additionally, as illustrated in FIG. 6B, these combinations can also be combinations of the substances to be measured T1, T2 and the dye-modified molecules M1, M2.

With the analysis device 5 according to the present embodiment, the detector 15 is shared by the first reaction vessel 2A and the second reaction vessel 2B. Due to this, the analysis device can be miniaturized and manufacturing costs can be reduced.

### Embodiment 5

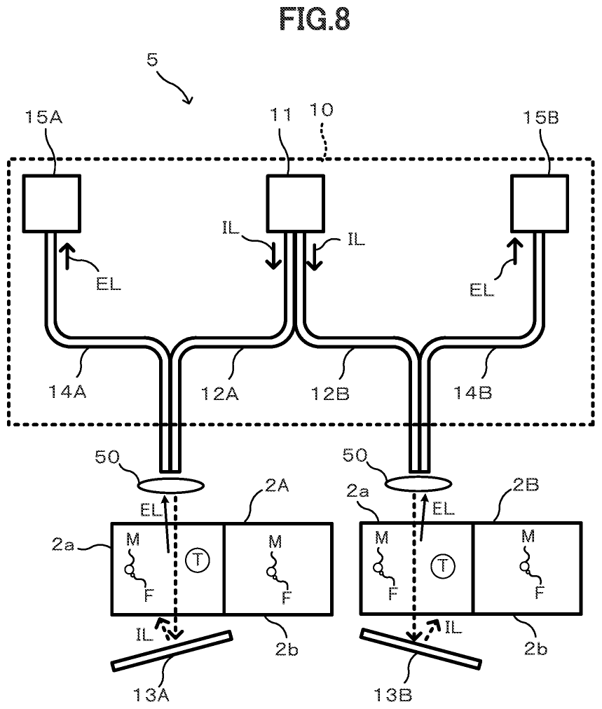

As illustrated in FIG. 8, an analysis device 5 according to the present embodiment includes, as a reaction vessel 2, a first reaction vessel 2A and a second reaction vessel 2B. An analysis device 5 includes a detection optical system 10 that individually detects an emission intensity P1, or the emission intensity P1 and a degree of polarization P2, of a fluorescence EL in the first reaction vessel 2A, and the emission intensity P1, or the emission intensity P1 and the degree of polarization P2, of the fluorescence EL in the second reaction vessel 2B.

The detection optical system 10 includes a light source unit 11, optical fibers 12A, 12B, reflecting mirrors 13A, 13B, optical fibers 14A, 14B, a first detector 15A, a second detector 15B, and a lens 50.

The light source unit 11 emits excitation light IL through the optical fiber 12A on the first chamber 2a of the first reaction vessel 2A via the lens 50, and emits the excitation light IL through the optical fiber 12B on the first chamber 2a of the second reaction vessel 2B via the lens 50. The excitation light IL causes the dye-modified molecule M in the first chamber 2a of the first reaction vessel 2A and the second reaction vessel 2B to emit light near the focus positions of the excitation light IL. The excitation light IL that transmits through the first chamber 2a of the first reaction vessel 2A diffuses/reflects in a diagonal direction at the reflecting mirror 13A, and the excitation light IL that transmits through the first chamber 2a of the second reaction vessel 2B diffuses/reflects in a diagonal direction at the reflecting mirror 13B.

The excitation light IL reflected at the reflecting minor 13A and the fluorescence EL generated in the first reaction vessel 2A are sent to the first detector 15A through the lens 50 and the optical fiber 14A. The excitation light IL reflected at the reflecting mirror 13B and the fluorescence EL generated in the second reaction vessel 2B are sent to the second detector 15B through the lens 50 and the optical fiber 14B. The configurations of the first detector 15A and the second detector 15B are the same as the configuration of the detector 15 illustrated in FIG. 4.

The first detector 15A detects the emission intensity P1, or the emission intensity P1 and the degree of polarization P2, of the fluorescence EL in the first reaction vessel 2A. The second detector 15B detects the emission intensity P1, or the emission intensity P1 and the degree of polarization P2, of the fluorescence EL in the second reaction vessel 2B.

Note that, as illustrated in FIG. 6A, combinations of the substance to be measured T and the dye-modified molecule M stored in the first reaction vessel 2A and the second reaction vessel 2B can be combinations of the substance to be measured T1 and the dye-modified molecule M1. Additionally, as illustrated in FIG. 6B, these combinations can also be combinations of the substances to be measured T1, T2 and the dye-modified molecules M1, M2.

With the analysis device 5 according to the present embodiment, the light source unit 11 is shared by the first reaction vessel 2A and the second reaction vessel 2B. A configuration is possible in which the target of the irradiation with the excitation light IL is the second chamber 2b, or both the first chamber 2a and the second chamber 2b.

### Embodiment 6

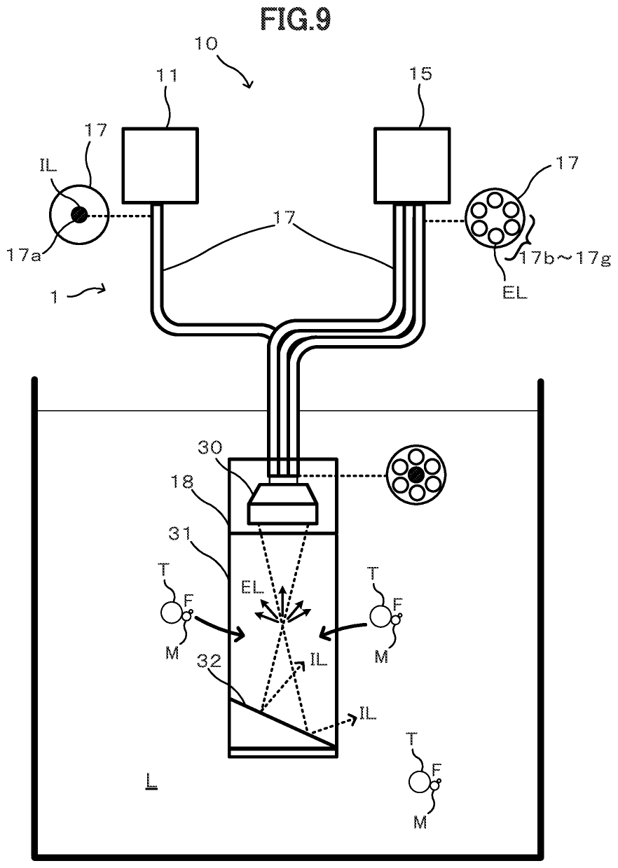

In an analysis device 5 according to the present embodiment, the configuration of the detection optical system 10 differs from those of Embodiments 4 and 5. As illustrated in FIG. 9, the detection optical system 10 includes a light source unit 11, an optical fiber bundle 17, a solution probe 18, and a detector 15.

The light source unit 11 emits an excitation light IL. The optical fiber bundle 17 is formed by bundling a plurality of optical fibers 17a to 17g. Of the optical fibers 17a to 17g, a first end of the optical fiber 17a, which is a center optical fiber, is connected to the light source unit 11, and first ends of the optical fibers 17b to 17g, which are peripheral optical fibers, are connected to the detector 15. Second ends of the optical fibers 17a to 17g are connected to the solution probe 18. Note that a configuration is possible in which an optical fiber 17a is used in which one end is split in two and connected to both the light source unit 11 and the detector 15.

The solution probe 18 includes a collimator lens 30, a sample opening 31, and a diagonally disposed reflecting minor 32. The collimator lens 30 converges and sends, into the sample opening 31, the excitation light IL emitted from the optical fiber 17a. The sample opening 31 is configured such that the substance to be measured T and the dye-modified molecule M can enter from outside. The substance to be measured T and the dye-modified molecule M that enter the sample opening 31 emit light due to the converged excitation light IL and generate a fluorescence EL. The reflecting minor 32 diffuses/reflects the excitation light IL. Note that a configuration is possible in which the solution probe 18 is covered by a light-blocking cylinder. An inner side of the light-blocking cylinder is painted black, and the light-blocking cylinder prevents stray light from outside from entering the solution probe 18. Covering the solution probe 18 with the light-blocking cylinder makes it possible to monitor fluorescence signals with high accuracy without being affected by the state of the other chamber.

The fluorescence EL that enters the optical fibers 17b to 17g via the collimator lens 30 is sent to the detector 15. The detector 15 detects an emission intensity P1, or the emission intensity P1 and a degree of polarization P2, of the fluorescence EL in a first reaction vessel 2A.

Thus, simple detection can be carried out by using the detection optical system 10 including the optical fiber bundle 17, and the solution probe 18 with which the collimator lens 30, the reflecting minor 32, and the like are integrated and, as such, the efficiency of detection work can be improved and detection time can be shortened.

Note that the optical fiber bundle 17 is obtained by bundling the seven optical fibers 17a to 17g, but the number of optical fibers to be bundled may be any number. Additionally, the excitation light IL may be sent by a plurality of optical fibers.

In the embodiment described above, the first reaction vessel 2A and the second reaction vessel 2B are provided as the reaction vessel 2. However, a configuration is possible in which the reaction vessel 2 is implemented as three or more reaction vessels. Such a configuration enables the detection of the same substance to be measured T contained in three or more specimens, and the detection of three or more types of substances to be measured T contained in the specimen S.

Note that, in the embodiment described above, the molecule M is modified with the fluorochrome F, but the present disclosure is not limited thereto. For example, a configuration is possible in which the molecule M is modified with a phosphorescent dye. Provided that the molecule M is detectable by the detection optical system, other dyes may be used.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A substance separating device, comprising:
a reaction vessel provided with an interior that is partitioned into a first chamber and a second chamber by a dialysis membrane, a solution being stored in the reaction vessel, wherein
a specimen is stored in the first chamber,
a dye-modified molecule that has a binding ability for specifically binding to a substance to be measured is stored in at least one of the first chamber and the second chamber, the substance to be measured being included in the specimen and having a molecular weight that is greater than a molecular weight cut-off the dialysis membrane, and
the dye-modified molecule has a molecular weight that is less than the molecular weight cut-off of the dialysis membrane.

2. The substance separating device according to claim 1, wherein
the reaction vessel includes a first reaction vessel and a second reaction vessel, an interior of each of the first reaction vessel and the second reaction vessel being partitioned into a first chamber and a second chamber,
specimens of mutually different types are stored and, also a dye-modified molecule of an identical type is stored in the first reaction vessel and the second reaction vessel, or
specimens of identical types and, also, dye-modified molecules of mutually different types are stored in the first reaction vessel and the second reaction vessel.

3. An analysis device, comprising:
the substance separating device according to claim 1; and
a detection optical system that emits excitation light that causes a dye to emit light on at least one of a first chamber and a second chamber of a reaction vessel of the substance separating device and, also, detects an emission intensity of a portion on which the excitation light is emitted, or the emission intensity and a degree of polarization of the portion on which the excitation light is emitted.

4. The analysis device according to claim 3, wherein the detection optical system detects the emission intensity and the degree of polarization of the portion on which the excitation light is emitted.

5. An analysis device comprising:
the substance separating device according to claim 2;
a first light source that emits a first excitation light on a first reaction vessel of the substance separating device, the first excitation light causing a first dye to emit light;
a second light source that emits a second excitation light on a second reaction vessel of the substance separating device, the second excitation light causing a second dye to emit light; and
a detector that individually detects an emission intensity in the first reaction vessel, or the emission intensity and a degree of polarization, in the first reaction vessel, and the emission intensity, or the emission intensity and the degree of polarization, in the second reaction vessel, wherein
a dye-modified molecule stored in the first reaction vessel is modified with the first dye, and
a dye-modified molecule stored in the second reaction vessel is modified with the second dye.

6. An analysis device comprising:
the substance separating device according to claim 2;
a light source that emits excitation light on a first reaction vessel and a second reaction vessel of the substance separating device, the excitation light causing a dye to emit light;
a first detector that detects an emission intensity in the first reaction vessel, or the emission intensity and a degree of polarization in the first reaction vessel; and
a second detector that detects the emission intensity in the second reaction vessel, or the emission intensity and the degree of polarization in the second reaction vessel.

7. An analysis method comprising:
storing a specimen in, of a first chamber and a second chamber of a reaction vessel in which a solution is stored and that is partitioned by a dialysis membrane, the first chamber; and
storing, in at least one of the first chamber and the second chamber, a dye-modified molecule that has a binding ability for specifically binding to a substance to be measured and that has a molecular weight that is less than a molecular weight cut-off of the dialysis membrane, the substance to be measured being included in the specimen and having a molecular weight that is greater than the molecular weight cut-off of the dialysis membrane.

8. The analysis method according to claim 7, further comprising:
emitting, on at least one of the first chamber and the second chamber, an excitation light that causes a dye to emit light and, also, detecting an emission intensity of a portion, of the first chamber and the second chamber, on which the excitation light is emitted, or the emission intensity and a degree of polarization of the portion, of the first chamber and the second chamber, on which the excitation light is emitted.
